(19) United States
(12) Patent Application Publication
(10) Pub. No.: US 2014/0266536 A1
(43) Pub. Date: Sep. 18, 2014

(54) FERRITE CORE WINDING STRUCTURE WITH HIGH FREQUENCY RESPONSE

(71) Applicant: Shan-Jui Lu, Xizhi City (TW)

(72) Inventor: Shan-Jui Lu, Xizhi City (TW)

(73) Assignee: Lantek Electronics Inc., Xizhi City (TW)

(21) Appl. No.: 14/215,744

(22) Filed: Mar. 17, 2014

Related U.S. Application Data
(60) Provisional application No. 61/789,386, filed on Mar. 15, 2013.

(51) Int. Cl. H01F 27/28

(52) U.S. Cl. CPC H01F 27/2895
USPC 336/178

(57) ABSTRACT

The present invention provides a ferrite core winding structure with high frequency response, which comprises: a ferrite core formed with at least a penetrated hole, a first enamel wire formed with a first end and a second end, and a second enamel wire formed with a first end and a second end; wherein, the first end of the first enamel wire and the first end of the second enamel wire are mutually twisted for at least one turn and then jointly passed the penetrated hole, the second end of the first enamel wire and the second end of the second enamel wire are jointly encircled the ferrite core then passed the penetrated hole, the second end of the first enamel wire is respectively encircled the ferrite core for at least one turn at two sides of the winding formed by the first end of the first enamel wire, then the second end of the first enamel wire and the first end of the second enamel wire are twisted for plural turns at the outer side of the ferrite core thereby forming a common end.

### CROSS-REFERENCE TO RELATED APPLICATIONS

This application claims benefit under 35 U.S.C. §119(e) of U.S. Provisional Application Ser. No. 61/789,386, entitled “FERRITE CORE WINDING STRUCTURE WITH HIGH FREQUENCY RESPONSE,” filed Mar. 15, 2013, naming Shan-Jui Lu as the inventor, the complete disclosure being incorporated herein by reference.

### BACKGROUND OF THE INVENTION

1. Field of the Invention

The present invention relates a ferrite core winding structure, especially to a ferrite core winding structure with high frequency response in which a pair of enamel wires are mutually twisted and encircle the ferrite core with various wire stacking means, thereby achieving the functions of expanding bandwidth and preventing interference.

2. Description of Related Art

Referring from FIG. 1(a) to FIG. 1(d), wherein FIG. 1(a) is a schematic view illustrating the left side of a conventional ferrite core winding structure; FIG. 1(b) is a schematic view illustrating the front side of the conventional ferrite core winding structure; FIG. 1(c) is a schematic view illustrating the right side of the conventional ferrite core winding structure; and FIG. 1(d) is a schematic view illustrating the bottom side of the conventional ferrite core winding structure. As shown in FIGS. 1(a) to 1(d), a conventional ferrite core winding structure is often installed with a ferrite core 110, a first enamel wire 120 and a second enamel wire 130. Wherein, the ferrite core 110 is formed with a penetrated hole 111. A first end 121 of the first enamel wire 120 is passed through the penetrated hole 111 and then encircles the ferrite core 110 for one turn. A first end 131 of the second enamel wire 130 is passed through the penetrated hole 111 and then encircles the ferrite core 110 for two turns respectively at two sides of the winding formed by the first enamel wire 120. Then, the first end 121 of the first enamel wire 120 and the first end 131 of the second enamel wire 130 are mutually twisted at the outer side of the ferrite core 110, thereby forming a common end. However, the mentioned conventional ferrite core winding structure has following disadvantages: 1. the first enamel wire 120 and the second enamel wire 130 are arranged in parallel, so the two enamel wires mutually interferes with each other during transmission; 2. the performance of transmitting in the high frequency of 1,525 MHz is poor.

Referring from FIG. 2(a) to FIG. 2(c), wherein FIG. 2(a) is a schematic view illustrating the insertion loss between a RF signal input connector and a first RF signal output connector while the conventional ferrite core winding structure is installed in a distributor; FIG. 2(b) is a schematic view illustrating the insertion loss between the RF signal input connector and a second RF signal output connector while the conventional ferrite core winding structure is installed in the distributor; and FIG. 2(c) is a schematic view illustrating the isolation between the first RF signal output connector and the second RF signal output connector while the conventional ferrite core winding structure being installed in a distributor.

As shown in FIG. 2(a), the insertion loss between the RF signal input connector and the first RF signal output connector of the distributor is −3.7567 dB, −4.0795 dB and −9.4732 dB respectively at the location of ∇4, ∇5 and ∇6.

As shown in FIG. 2(b), the insertion loss between the RF signal input connector and the second RF signal output connector of the distributor is −3.8535 dB, −4.1728 dB and −9.3696 dB respectively at the location of ∇4, ∇5 and ∇6.

Referring to FIG. 2(c), the isolation between the first RF signal output connector and the second RF signal output connector of the distributor is −26.254 dB and −16.978 dB respectively at the location of ∇5 and ∇6.

As such, the insertion loss and the isolation of the distributor installed with the conventional ferrite core winding structure is notably degraded at the location of ∇5.

In view of the disadvantages of the mentioned conventional ferrite core winding structure, the present invention provides a ferrite core winding structure with high frequency response for improving the disadvantages.

### SUMMARY OF THE INVENTION

One primary objective of the present invention is to provide a ferrite core winding structure with high frequency response in which a pair of enamel wires are mutually twisted and encircles the ferrite core with various wire stacking means, thereby achieving the functions of expanding bandwidth and preventing interference.

Another objective of the present invention is to provide a ferrite core winding structure with high frequency response, which is capable of reducing the signal interference level and preventing the radiation loss during signal transmission in high frequency.

For achieving aforesaid objectives, the present invention provides a ferrite core winding structure with high frequency response, which comprises: a ferrite core formed with at least a penetrated hole, a first enamel wire formed with a first end and a second end, and a second enamel wire formed with a first end and a second end; wherein, the first end of the first enamel wire and the first end of the second enamel wire are mutually twisted for at least one turn, then the first ends of the first and the second enamel wires are jointly passed the penetrated hole, the second end of the first enamel wire and the second end of the second enamel wire are jointly encircled the ferrite core then passed the penetrated hole, the second end of the first enamel wire is respectively encircled the ferrite core for at least one turn at two sides of the winding formed by the first end of the first enamel wire, then the second end of the first enamel wire and the first end of the second enamel wire are twisted for plural turns at the outer side of the ferrite Ore thereby forming a common end.

### BRIEF DESCRIPTION OF THE DRAWINGS

The present invention will be apparent to those skilled in the art by reading the following detailed description of a preferred embodiment thereof, with reference to the attached drawings, in which:

FIG. 1(a) is a schematic view illustrating the left side of a conventional ferrite core winding structure;

FIG. 1(b) is a schematic view illustrating the front side of the conventional ferrite core winding structure of FIG. 1(a);

FIG. 1(c) is a schematic view illustrating the right side of the conventional ferrite core winding structure of FIG. 1(a);

FIG. 1(d) is a schematic view illustrating the bottom side of the conventional ferrite core winding structure of FIG. 1(a);

FIG. 2(a) is a schematic view illustrating the insertion loss between an RF signal input connector and a first RF signal output connector while the conventional ferrite core winding structure of FIG. 1(a) is installed in a distributor;

FIG. 2(b) is a schematic view illustrating the insertion loss between the RF signal input connector and a second RF signal output connector while the conventional ferrite core winding structure of FIG. 1(a) is installed in the distributor;

FIG. 2(c) is a schematic view illustrating the isolation between the first RF signal output connector and the second RF signal output connector while the conventional ferrite core winding structure of FIG. 1(a) is installed in a distributor;

FIG. 3(a) is a schematic view illustrating the left side of the ferrite core winding structure with high frequency response according to an embodiment of the present invention;

FIG. 3(b) is a schematic view illustrating the front side of the ferrite core winding structure of FIG. 3(a) with high frequency response according to an embodiment of the present invention;

FIG. 3(c) is a schematic view illustrating the right side of the ferrite core winding structure of FIG. 3(a) with high frequency response according to an embodiment of the present invention;

FIG. 3(d) is a schematic view illustrating the bottom side of the ferrite core winding structure of FIG. 3(a) with high frequency response according to an embodiment of the present invention;

FIG. 4(a) is a schematic view illustrating the insertion loss between a RF signal input connector and a first RF signal output connector while the ferrite core winding structure of FIG. 3(a) with high frequency response is installed in a distributor according to an embodiment of the present invention;

FIG. 4(b) is a schematic view illustrating the insertion loss between the RF signal input connector and a second RF signal output connector while the ferrite core winding structure of FIG. 3(a) with high frequency response is installed in a distributor according to an embodiment of the present invention; and

FIG. 4(c) is a schematic view illustrating the isolation between the first RF signal output connector and the second RF signal output connector while the ferrite core winding structure with high frequency response is installed in a distributor according to an embodiment of the present invention.

### DETAILED DESCRIPTION OF THE PREFERRED EMBODIMENT

Referring from FIG. 3(a) to FIG. 3(d), wherein FIG. 3(a) is a schematic view illustrating the left side of the ferrite core winding structure with high frequency response according to an embodiment of the present invention; FIG. 3(b) is a schematic view illustrating the front side of the ferrite core winding structure with high frequency response according to an embodiment of the present invention; FIG. 3(c) is a schematic view illustrating the right side of the ferrite core winding structure with high frequency response according to an embodiment of the present invention; and FIG. 3(d) is a schematic view illustrating the bottom side of the ferrite core winding structure with high frequency response according to an embodiment of the present invention.

As shown in FIGS. 3(a) to 3(d), the ferrite core winding structure with high frequency response provided by the present invention comprises: a ferrite core 10; a first enamel wire 20; and a second enamel wire 30.

The ferrite core 10 may be, for example, but not limited to, formed in a cylindrical shape and formed with at least a penetrated hole 11.

The first enamel wire 20 is formed with a first end 22 and a second end 23.

The second enamel wire 30 is formed with a first end 31 and a second end 32.

The first end 22 of the first enamel wire 20 and the first end 31 of the second enamel wire 30 are mutually twisted for at least one turn. Then, the first ends 22, 31 of the two enamel wires 20, 30 are jointly passed through the penetrated hole 11. The second end 23 of the first enamel wire 20 and the second end 32 of the second enamel wire 30 jointly encircles the ferrite core 10 and then passed through the penetrated hole 11. The second end 23 of the first enamel wire 20 respectively encircles the ferrite core 10 for at least one turn at two sides of the winding formed by the first end 22 of the first enamel wire 20. Then, the second end 23 of the first enamel wire 20 and the first end 31 of the second enamel wire 30 are twisted for plural turns at the outer side of the ferrite core 10 thereby forming a common end.

The first end 22 of the first enamel wire 20 may be, for example, but not limited to, coupled to a ground wire.

The second end 32 of the second enamel wire 30 may be, for example, but not limited to, coupled to a signal wire. The common end may also be formed as an intermediate tapping end. Accordingly, with the above-mentioned structure, the ferrite core winding structure with high frequency response provided by the present invention is enabled to be formed as a transformer having a winding ratio of 4:1 and having an intermediate tapping effect.

The first end 31 of the second enamel wire 30 is then twisted with the second end 23 of the first enamel wire 20 for example, but not limited to, two to four turns.

The second end 32 of the second enamel wire 30 encircles the ferrite core 10, for example, but not limited to, two turns respectively at two sides of the second end 23 of the first enamel wire 20. As such, when current signals pass the first enamel wire 20 and the second enamel wire 30, an electromagnetic field is generated, so the first enamel wire 20 and the second enamel wire 30 transmitting in parallel mutually interfere with each other. According to the present invention, an action of twisting the two enamel wires 20, 30 for two to four turns is processed then flatly provided at the outer side of the ferrite core 10, thereby allowing electromagnetic field in various directions to be mutually counterbalanced. Through the first end 22, which is connected to the ground end, of the first enamel wire 20 encircles the ferrite core 10 for at least one turn respectively at two sides of the winding formed by the second end 23 of the first enamel wire 20, according to the present invention. Winding for 2 turns is adopted for illustration and shall not be deemed as a limitation to the scope of the present invention, and with various wire stacking sequence means for covering the signal wire of the second enamel wire 30 having single winding, an effect of preventing the radiation loss during signal transmission is achieved thereby allowing the bandwidth to be expanded.

Referring from FIG. 4(a) to FIG. 4(c), wherein FIG. 4(a) is a schematic view illustrating the insertion loss between a RF signal input connector and a first RF signal output connector while the ferrite core winding structure with high frequency response is installed in a distributor according to an embodiment of the present invention; FIG. 4(b) is a schematic view illustrating the insertion loss between the RF signal input connector and a second RF signal output connector while the ferrite core winding structure with high frequency response is installed in a distributor according to an embodiment of the present invention; and FIG. 4(c) is a schematic view illustrating the isolation between the first RF signal output connector and the second RF signal output connector while the ferrite core winding structure with high frequency response is installed in a distributor according to an embodiment of the present invention.

As shown in FIG. 4(a), when the ferrite core winding structure with high frequency response of the present invention is applied in a distributor (not shown in figures), wherein the distributor is installed with a RF signal input connector, a first RF signal output connector, a second RF signal output connector. Wherein, the RF signal input connector is used for inputting signals to the distributor; the first RF signal output connector is used for outputting RF signals to a television unit (not shown in figures); and the second RF signal output connector is used for outputting RF signals to another television unit (not shown in figures), and signals can be mutually transmitted between the first RF signal output connector and the second RE signal output connector within the applied frequency band.

The insertion loss between the RF signal input connector and the first RF signal output connector of the distributor is −3.9271 dB, −4.1147 dB and −4.7729 dB respectively at the location of ∇6, ∇7 and ∇8. Compared to what is shown FIG. 2(a), for the distributor installed with the conventional ferrite core winding structure, the insertion loss between the RF signal input connector and the first RF signal output connector of the distributor is −3.7567 dB, −4.0795 dB and −9.4732 dB respectively at the location of ∇4, ∇5 and ∇6. As such, the distributor installed with the ferrite core winding structure provided by the present invention has smaller insertion loss between the RF signal input connector and the first RF signal output connector, and the transmission bandwidth is enabled to be expanded to 1.7 GHz.

As shown in FIG. 4(b), the insertion loss between the RF signal input connector and the second RF signal output connector of the distributor is −3.6445 dB, −3.8610 dB and −4.6980 dB respectively at the location of ∇6, ∇7 and ∇8. Compared to what is shown in FIG. 2(b), for the distributor installed with the conventional ferrite core winding structure, the insertion loss between the RF signal input connector and the second RF signal output connector of the distributor is −3.8535 dB, −4.1728 dB and −9.3696 dB respectively at the location of ∇4, ∇5 and ∇6. As such, the distributor installed with the ferrite core winding structure provided by the present invention has smaller insertion loss between the RF signal input connector and the second RF signal output connector, and the transmission bandwidth is enabled to be expanded to 1.7 GHz.

Referring to FIG. 4(c), the isolation between the first RF signal output connector and the second RF signal output connector of the distributor is −23.779 dB, −16.610 dB and −17.991 dB respectively at the location of ∇7, ∇8 and ∇9. Compared to what is shown in FIG. 2(c), for the distributor installed with the conventional ferrite core winding structure, the isolation between the first RF signal output connector and the second RF signal output connector of the distributor is −26.254 dB and −16.978 dB respectively at the location of ∇5 and ∇6. As such, the distributor installed with the ferrite core winding structure provided by the present invention has better isolation between the first RF signal output connector and the second RF signal output connector, and also has better electrical characteristic within the range of 1,125 MHz to 1,675 MHz, and the frequency band application is better.

As such, according to the present invention, a pair of enamel wires are mutually twisted and encircled the ferrite core with various wire stacking means, thereby achieving the functions of expanding bandwidth and preventing interference, so the ferrite core winding structure with high frequency response of the present invention is novel comparing to the conventional ferrite core winding structure.

As what has been disclosed above, the ferrite core winding structure with high frequency response of the present invention has following advantages: a pair of enamel wires are mutually twisted and encircled the ferrite core with various wire stacking means, thereby achieving the functions of expanding bandwidth and preventing interference; capable of reducing the signal interference level and preventing the radiation loss during signal transmission in high frequency; and having a better performance while transmitting in the high frequency of 1,675 MHz. Accordingly, the ferrite core winding structure with high frequency response of the present invention is more practical in use and has the nonobvious characteristic comparing to the conventional ferrite core winding structure.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A ferrite core winding structure with high frequency response, comprising:
a ferrite core formed with at least a penetrated hole;
a first enamel wire formed with a first end and a second end; and
a second enamel wire formed with a first end and a second end;
wherein, said first end of said first enamel wire and said first end of said second enamel wire being mutually twisted for at least one turn, then said first ends of said first and said second enamel wires being jointly passed said penetrated hole, said second end of said first enamel wire and said second end of said second enamel wire being jointly encircled said ferrite core then passed said penetrated hole, said second end of said first enamel wire being respectively encircled said ferrite core for at least one turn at two sides of the winding formed by said first end of said first enamel wire, then said second end of said first enamel wire and said first end of said second enamel wire being twisted for plural turns at the outer side of said ferrite core thereby forming a common end.

2. The ferrite core winding structure with high frequency response as claimed in claim 1, wherein said first end of said first enamel wire is coupled to a ground wire.

3. The ferrite core winding structure with high frequency response as claimed in claim 1, wherein said second end of said second enamel wire is coupled to a signal wire.

4. The ferrite core winding structure with high frequency response as claimed in claim 1, wherein said first end of said second enamel wire is further twisted with said second end of said first enamel wire for two to four turns.

5. The ferrite core winding structure with high frequency response as claimed in claim 1, wherein said second end of said second enamel wire is encircled said ferrite core for two turns respectively at two sides of said second end of said first enamel wire.

6. The ferrite core winding structure with high frequency response as claimed in claim 1, wherein said common end is formed as an intermediate tapping end.
